(19) United States
(12) Patent Application Publication
(10) Pub. No.: US 2004/0000410 A1
(43) Pub. Date: Jan. 1, 2004

(54) Building fire protection system and method for extinguishing airplane fuel fires

(76) Inventor: Scott Burns, Chicago, IL (US)

Correspondence Address: LITTMAN LAW OFFICES, LTD., P.O. BOX 15035 CRYSTAL CITY STATION, ARLINGTON, VA, 22215, US

(21) Appl. No.: 10/184,994

(22) Filed: Jul. 1, 2002

(51) Int. Cl. A62C 35/00

(52) U.S. Cl. 169/47; 169/46; 169/54; 169/16; 169/14; 169/44

(57) ABSTRACT

The invention is a fire protection system and method to protect a building against airplane fuel fires. The components of the fire protection system include a central annunciator panel, a supply line network tied into a plurality of fire retardant reservoirs to transmit extinguishing material throughout the fire protection system, an exhaust system to expel harmful smoke and fumes coming from an airplane fuel fire and a standpipe system with a fire hose to extinguish localized airplane fuel fires. The fire protection system can also be controlled either by personal computer or microprocessor.

### BACKGROUND OF THE INVENTION

1. Field of the Invention

The present invention relates to a building fire protection system and method for extinguishing airplane fuel fires.

2. Description of the Related Art

Fire protection is an important science that is involved with protecting a wide range of occupancies. Low hazard occupancies such as office buildings and retail stores as well as high hazard occupancies such as industrial and chemical facilities can all require some form of fire protection. Typically these higher hazard occupancies require extensive and sophisticated protection, however, even lower hazard occupancies and settings can also benefit from more extensive and sophisticated protection. This is shown in the related art.

U.S. Pat. No. 3,602,313 issued to Achs, outlines a fire protection system for an automated high-rise warehouse which includes a roof mounted high expansion foam generator mounted on a stacker crane for movement therewith. Upon a sensing of a fire, a signal is sent to a central control to indicate the presence and location of a fire. The central control then effects movement of the stacker crane to the location of the fire and initiates operation of a foam generator mounted on the stacker crane to the location of the fire.

U.S. Pat. No. 4,091,874 issued to Monma, outlines a method and system for extinguishing fires in large buildings. The system contains a plurality of fire fighting sections wherein a fire occurring in any of the fire fighting sections is detected to signal a central control panel, which produces a warning in that section indicating to occupants that they should quickly leave. The fire fighting sections in which the fire occurs are shut tight by fire doors or the like for a predetermined time after the warning is provided and after the occupants have escaped.

U.S. Pat. No. 4,181,179 issued to Batte, outlines a method and apparatus for instantaneous response and control of an aircraft or airfield fire. An array of fire retardant nozzles are interconnected to a fire retardant supply system, which is provided alongside a runway of an airport and is interconnected with a computerized control network for remote actuation thereof. A series of different types of sensors are provided in conjunction with the retardant nozzle system for detecting heat of the type produced from an aircraft and/or runway fire or incident.

U.S. Pat. No. 4,691,783 issued to Stern et al., outlines a module for use in a fire extinguishing system and has a housing which contains a detector apparatus for detecting characteristics of a fire or an incipient fire. A control apparatus is adapted to be actuated by detection at the detector apparatus and a fire extinguishing apparatus is also adapted to be discharged by the control apparatus.

U.S. Pat. No. 5,278,749 issued to DeMan, outlines a method and apparatus related to the control of water flow to sprinklers and sprinkler lines. More specifically, the invention is a centralized sprinkler flow control apparatus and method that does not utilize remote electric lines.

U.S. Pat. No. 5,905,450 issued to Kim et al., outlines a system for supporting a fire fighting procedure which is capable of more effectively performing a fire fighting operation in real-time. The system includes a tracker for extracting the moving direction and speed of a fire fighter in a building. A see-through head-mounted display device for extracting a seeing direction of the fire fighter and providing a current position of a fire fighter, including graphic and text information to the fire fighter is also included.

Although each of these patents describe useful systems and methods, U.S. Pat. No. 4,181,179 issued to Batte is of particular interest since it deals with airplane fuel fire protection, a source of greater interest since the World Trade Center and Pentagon disasters. This is an important type of fire protection and is in great demand since these tragic events. It would be of great interest to people to find a system and method that can be used with a building that can extinguish airplane fuel fires.

None of the above inventions and patents, taken either singularly or in combination, is seen to describe the instant invention as claimed. Thus a fire prevention system for airplane fuel fires solving the aforementioned problems is desired.

### SUMMARY OF THE INVENTION

The invention is a fire protection system and method to protect a building against airplane fuel fires. The components of the fire protection system include a central annunciator panel, a supply line network tied into a plurality of fire retardant material reservoirs to transmit extinguishing material throughout the fire protection system, an exhaust system to expel harmful smoke and fumes coming from an airplane fuel fire and a standpipe system with a fire hose to extinguish localized airplane fuel fires. The fire protection system can also be controlled either by personal computer or microprocessor.

Accordingly, it is a principal object of the invention to provide an extinguishing system for a building that can extinguish an airplane fuel fire.

It is another object of the invention to provide a standpipe for extinguishing an airplane fuel fire.

It is a further object of the invention to provide a fire protection system for buildings near an airport or airfield.

Still another object of the invention is to provide a fire protection system that will reduce property damage and loss of life to a high rise building that is struck by an aircraft.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a fire protection system for airplane fuel fires according to the present invention.

FIG. 2 is a system overview of a fire protection system for airplane fuel fires.

FIG. 3 is an overview of the overall method for extinguishing airplane fuel fires.

Similar reference characters denote corresponding features consistently throughout the attached drawings.

### DETAILED DESCRIPTION OF THE PREFERRED EMBODIMENT

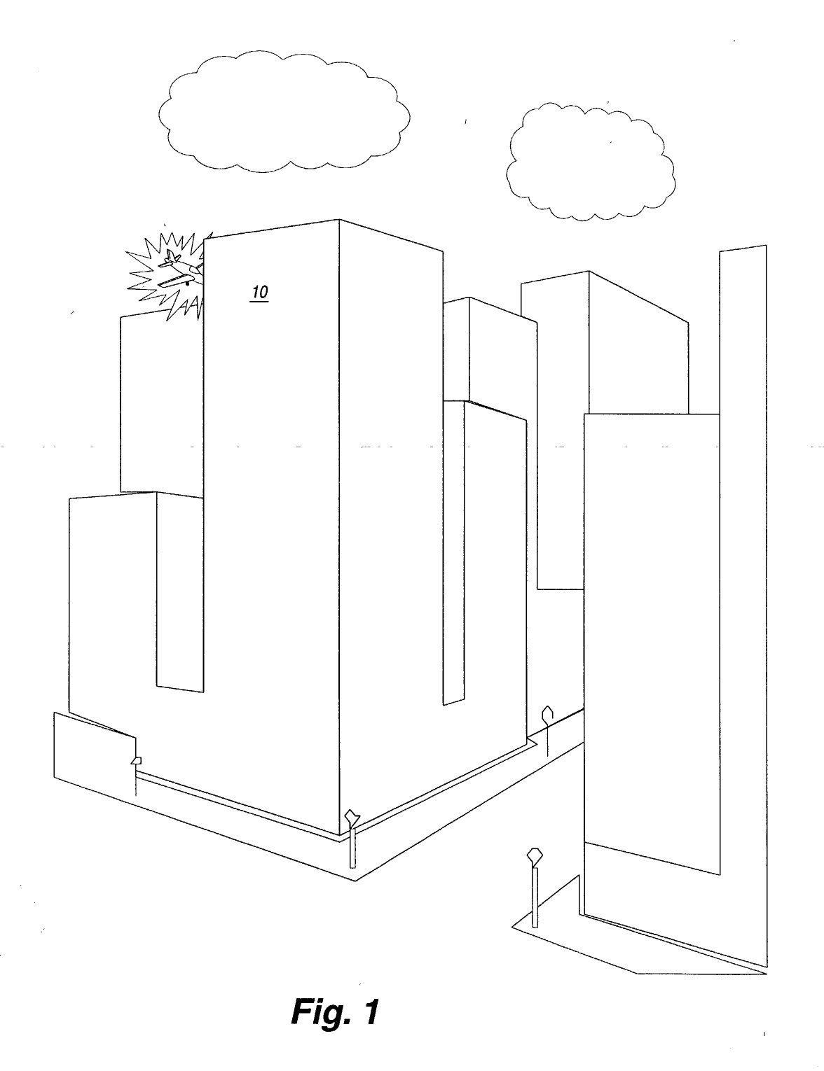

The present invention is a fire protection system 10 and method 200 to protect a building against airplane fuel fires. The invention can be used for protecting high profile skyscrapers as well as buildings associated with airports and airfields, such as airplane hangars, airports and maintenance buildings. This is depicted in FIG. 1.

The fire protection system 10 comprises a central annunciator panel 20 with a means for controlling the fire protection system 10, a means for activating the fire protection system 10, and a supply line network 30 tied into a plurality of fire retardant material reservoirs 40 to transmit extinguishing material throughout the fire protection system 10. The fire protection system 10 further comprises a means for dispersing extinguishing material from the supply line network 30 directly onto an airplane fuel fire to extinguish the airplane fuel fire. An exhaust system 50 is provided to expel harmful smoke and fumes coming from an airplane fuel fire and a standpipe system 60 is also provided to extinguish localized airplane fuel fires.

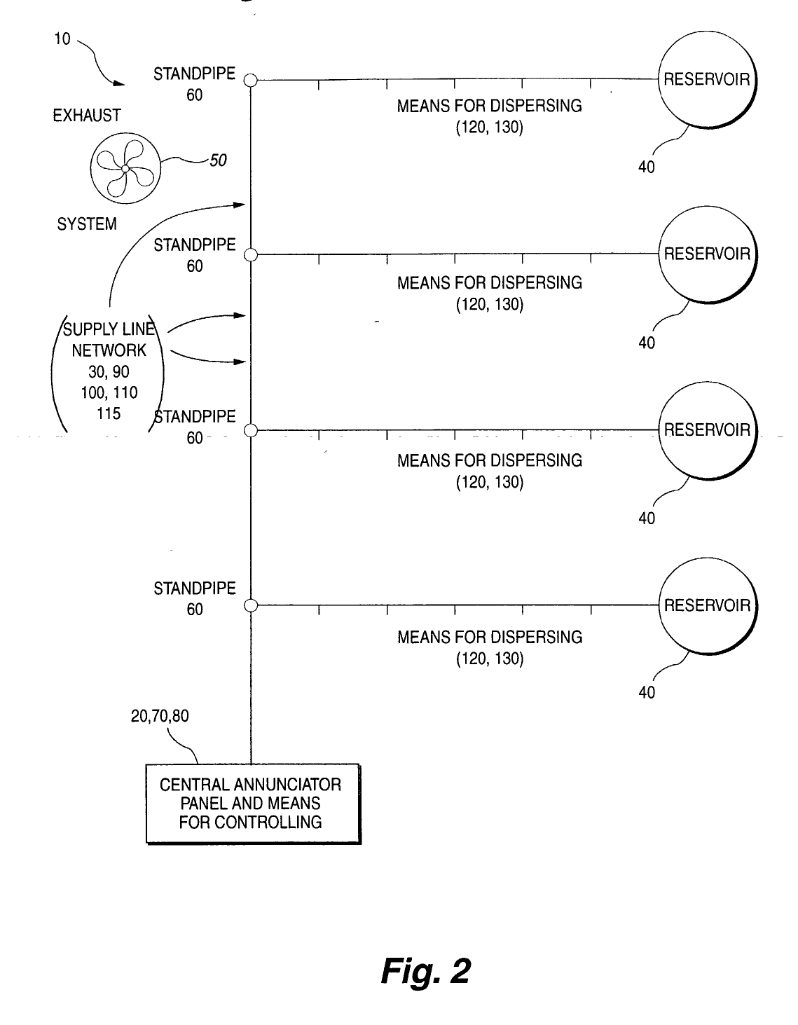

As diagramed in FIG. 2, the fire protection system 10 has several means for controlling the fire protection system 10. These include the use of a personal computer 70 as the means for controlling the fire protection system 10. Such a personal computer 70 would include a central processing unit (not shown) as well as computer media storage capabilities and computer code for executing and storing desired instructions that would control all of the various components of the fire protection system 10. The personal computer 70 would also have to be integrated into the central annunciator panel 20 of the fire protection system 10.

Similarly, a microprocessor 80 could also be employed for controlling the operations of the fire protection system 10. Such a microprocessor 80 would have to have programmed microchips with the capability to execute and store all of the desired instructions. A power source, oscillator, timer and LCD light source (not shown) would also need to complement the programmed microchips, which can easily be coded with any desired basic instructions, as is well-known to those schooled in the related art.

There are also has a number of different ways for activating the fire protection system 10. These are integrated throughout the supply line network 30 and include heat detectors 90, hard-wire smoke detectors 100 as well as manual pull boxes 110. These and other fire system activation components can be used as a means for activating the fire protection system 10. The described heat detectors 90, hard-wire smoke detectors 100 and manual pull boxes 110 are all common activating components of many known and used fire protection systems.

The fire protection system 10 also has a variety of protocols for dispersing extinguishing material onto an airplane fuel fire. These must include ways of dispersing a variety of fire retardant protein-based foams, aqueous film-forming alcohol resistant foams and high expansion foams, all of which are currently well-known and used in a variety of fire protection systems. The more commonly used water sprinkler heads (not shown) are not included as a means for dispersing, since the dispersed media being used (water) can make certain types of fires worse and can contribute to the severity of certain types of fires. The means for dispersing extinguishing material includes a plurality of sprinkler heads (non water) 120 and a plurality of nozzles 130 for these foam-based extinguishing materials.

As is also shown in FIG. 2, a fire retardant material reservoir 40, a standpipe 60, a supply line network 30 and apparatus for dispersing extinguishing material are designed to be on each floor of a building protected by the fire protection system 10. An exhaust system 50 is also provided throughout a building that is protected by the fire protection system 10. This is an important component of the fire protection system 10, which expels harmful and noxious fumes that are generated in a airplane fuel fire. The fire protection system 10 also has the capability of sharing fire retardant material reservoirs 40 in the event that a fire retardant material reservoir 40 runs out of or gets depleted of extinguishing material. This is another important component that is programmed into the fire protection system 10.

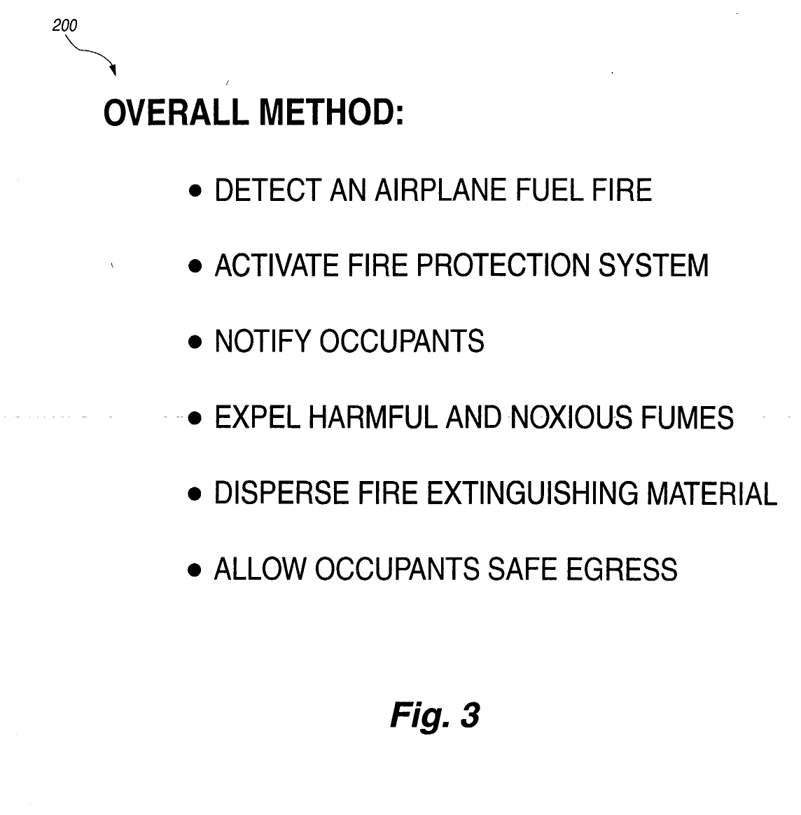

FIG. 3 outlines the overall method 200 of protecting a building and its occupants from an airplane fuel fire. The overall method 200 comprises the steps of detecting an airplane fuel fire, activating a fire protection system 10 that protects the building with the airplane fuel fire, notifying occupants that the fire protection system 10 has been activated, expelling harmful and noxious fumes from the airplane fuel fire in the protected building, dispersing a fire extinguishing material directly onto the airplane fuel fire and extinguishing the airplane fuel fire and allowing occupants safe egress out of the building.

The overall method 200 incorporates the previously described fire protection system 10 in a protected building. The first step involves the step of detecting an airplane fuel fire. This involves certain components of the fire protection system 10 that also are activating the fire protection system 10 that protects the building, which is the second step of the overall method 200. These components were previously discussed as part of the fire protection system 10 and include heat detectors 90, hard-wire smoke detectors 100 and manual pull boxes 110.

Once the airplane fuel fire is detected and the fire protection system 10 is activated, the fire protection system 10 then notifies the occupants of the building. This is done primarily through the use of localized alarms 115 located throughout the supply line network 30. The central annunciator panel 20 is also notified and can actually indicate where the airplane fuel fire is in the building and if the local alarms are on and if extinguishing material is dispersed. Once the occupants of the building are notified, the fire protection system 10 will then expel harmful and noxious fumes that are generated by the airplane fuel fire. This is done throughout the building with an exhaust system 50, and addresses the problem of smoke inhalation by the occupants. The next step of the overall method 200 is dispersing fire extinguishing material directly onto the airplane fuel fire. This is done with a plurality of non-water sprinkler heads 120 and a plurality of nozzles 130, which are also tied into the central annunciator panel 20 of the fire protection system 10. If all of the previous steps of the overall method 200 are achieved with no problems, the final and most important step of the overall method 200 will occur, which is allowing the occupants of the protected building safe egress from the building and the airplane fuel fire.

It is to be understood that the present invention is not limited to the embodiment described above, but encompasses any and all embodiments within the scope of the following claims.

I claim:

1. A fire protection system to protect a building against airplane fuel fires comprising:
a central annunciator panel with a means for controlling the fire protection system;
a means for activating the fire protection system;
a supply line network tied into a plurality of fire retardant reservoirs to transmit extinguishing material throughout the fire protection system;
a means for dispersing extinguishing material from the supply line network directly onto an airplane fuel fire to extinguish the airplane fuel fire;
an exhaust system to expel harmful smoke and fumes coming from an airplane fuel fire; and
a standpipe system with a fire hose to extinguish localized airplane fuel fires.

2. The system according to claim 1, wherein the means for controlling the fire protection system is a personal computer.

3. The system according to claim 1, wherein the means for controlling the fire protection system is a microprocessor.

4. The system according to claim 1, wherein the means for activating the fire protection system are heat detectors.

5. The system according to claim 1, wherein the means for activating the fire protection system are manual pull boxes.

6. The system according to claim 1, wherein the means for activating the fire protection system are hard-wire smoke detectors.

7. The system according to claim 1, wherein the means for dispersing extinguishing material is a plurality of non-water sprinkler heads.

8. The system according to claim 1, wherein the means for dispersing extinguishing material is a plurality of nozzles.

9. A method of protecting a building and its occupants from an airplane fuel fire, comprising the steps of:
detecting an airplane fuel fire;
activating a fire protection system that protects the building;
notifying occupants that the fire protection system has been activated;
expelling harmful and noxious fumes from the airplane fuel fire in the protected building;
dispersing a fire extinguishing material directly onto the airplane fuel fire and extinguishing the airplane fuel fire; and
allowing occupants safe egress out of the building.

10. The method according to claim 9, wherein the step of activating the fire protection system that protects the building is effected with heat detectors.

11. The method according to claim 9, wherein the step of activating the fire protection system that protects the building is effected with hard-wire smoke detectors.

12. The method according to claim 9, wherein the step of activating the fire protection system that protects the building is effected with manual pull boxes.

13. The method according to claim 9, wherein the step of notifying occupants that the fire protection system has been activated is effected with a localized alarm.

14. The method according to claim 9, wherein the step of notifying occupants that the fire protection system has been activated is effected with a centralized annunciator panel.

15. The method according to claim 9, wherein the step of expelling harmful and noxious fumes from the airplane fuel fire in the protected building are effected by an exhaust system.

16. The method according to claim 9, wherein the step of dispersing a fire extinguishing material directly onto the airplane fuel fire is effected by non-water sprinkler heads.

17. The method according to claim 9, wherein the step of dispersing a fire extinguishing material directly onto the airplane fuel fire is effected by nozzles.

18. The method according to claim 9, wherein the step of dispersing a fire extinguishing material directly onto the airplane fuel fire is effected by a standpipe.

19. The method according to claim 9, wherein the step of dispersing a fire extinguishing material directly onto the airplane fuel fire further comprises the step of fire retardant material reservoirs sharing fire extinguishing material when becoming depleted.
